(19) United States
(12) Patent Application Publication
(10) Pub. No.: US 2018/0240114 A1
(43) Pub. Date: Aug. 23, 2018

(54) TRANSACTION VERIFICATION IN A CONSENSUS NETWORK

(71) Applicant: Alibaba Group Holding Limited, George Town (KY)

(72) Inventor: Ning Li, Hangzhou (CN)

(73) Assignee: Alibaba Group Holding Limited, George Town (KY)

(21) Appl. No.: 15/900,617

(22) Filed: Feb. 20, 2018

(30) Foreign Application Priority Data
Feb. 22, 2017 (CN) 201710096987.5

(51) Int. Cl. G06Q 20/40; H04L 9/06; H04L 29/08

(52) U.S. Cl. CPC G06Q 20/401; H04L 67/104; H04L 9/0637

(57) ABSTRACT

A transaction request sent by a terminal is received by a first block chain node and stored in a memory corresponding to the first block chain node. The transaction request is broadcast to second block chain nodes. The second block chain nodes store the transaction request in respective memories. At least one transaction request is obtained from the memory. The obtained at least one transaction request is packaged into a pre-processed block. The pre-processed block is broadcast to the second block chain nodes. Each second block node acquires, from another block chain node, a given transaction request identified in the pre-processed block when a determination is made that a respective memory of the second block node does not include the given transaction request. Each second block node performs consensus verification on the pre-processed block using the acquired given transaction request and transaction requests stored in its respective memory.

This application claims priority to Chinese Patent Application No. 201710096987.5, filed on Feb. 22, 2017, which is incorporated by reference in its entirety. The subject matter of the present invention is also related to U.S. patent application Ser. No. ______, filed on ______, which is incorporated by reference in its entirety.

### BACKGROUND

Through the use of block chain technology, also referred to as a distributed ledger technology, data that is stored in a block chain can provide benefits such as tamper-resistance and decentralization. The use of block chain technology can result in a data storage environment that can be safer and more convenient.

### SUMMARY

The present disclosure describes techniques for performing, using block chain nodes in a consensus network, consensus verification on a packet of requests.

Implementations of the described subject matter, including the previously described implementation, can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented in particular implementations, so as to realize one or more of the following advantages. First, adverse effects on consensus verification of transaction requests that are caused by a network failure can be reduced. Second, transaction processing accuracy of the block chain network can be improved.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 is a schematic diagram of an example of a method for completing consensus verification, according to an implementation of the present disclosure.

FIG. 2 is a block diagram of an example of a system for storing, by block chain nodes, received transaction requests by using preset distributed middleware according to an implementation of the present disclosure.

FIG. 3 is a block diagram of an example of a system for determining a to-be-verified characteristic value, according to an implementation of the present disclosure.

FIG. 4 is a block diagram of an example of a system for establishing a consensus by a consensus network, according to an implementation of the present disclosure.

FIG. 5 is a block diagram of an example of a transaction verification system, according to an implementation of the present disclosure.

FIG. 6 is a schematic diagram of another transaction verification system, according to an implementation of the present disclosure.

Like reference numbers and designations in the various drawings indicate like elements.

### DETAILED DESCRIPTION

The following detailed description describes techniques for performing consensus verification on a packet of requests using block chain nodes in a consensus network. The detailed description is presented to enable a person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

Implementations of the present disclosure provide techniques for transaction verification that can solve the problem of low processing accuracy for block chain transactions in conventional systems. For the purposes of the present disclosure, a “transaction request” refers to a request for a particular block chain transaction to be performed. For example, a transaction request may be a request to transfer a particular amount of digital currency from one account to another account.

In conventional systems, when a transaction request is received from a terminal, a block chain node may store the transaction request in a memory of its own. Additionally, the block chain node may broadcast the transaction request to other block chain nodes in a whole consensus network. Other block chain nodes, after receiving the transaction request, may store the transaction request in their respective memories. The block chain node may then obtain a number of transaction requests from its memory, package these transaction requests into a pre-processed block, and broadcast the pre-processed block to other block chain nodes in the whole consensus network. The purpose of the broadcast is to reach a consensus, for example, to determine whether the transaction requests need to be stored in the block chain as blocks.

However, in some cases, during a process in which a block chain node in a consortium chain broadcasts a received transaction request to other block chain nodes, other block chain nodes in the whole consensus network may not receive the transaction request broadcast that is sent by the block chain node. Non-receipt can be caused, for example, by one or more factors including a network failure. As a result, with respect to transaction requests stored in a memory corresponding to one block chain node, memories corresponding to other block chain nodes may be lacking one or more of the transaction requests. The block chain nodes that are lacking may affect a consensus verification result of the whole consensus network.

For example, assume that the whole consensus network has three block chain nodes: A, B, and C. Block chain node A may store five transaction requests: #1, #2, #3, #4, and #5. Block chain node B may store four transaction requests: #1, #2, #3, and #4. Block chain node C may store three transaction requests: #1, #2, and #3. The transaction requests can all be stored in memories corresponding to the respective block chain nodes. Block chain node A, for example, may package the five transaction requests #1, #2, #3, #4, and #5 into a pre-processed block. Block chain node A may then broadcast the pre-processed block to the other block chain nodes to initiate a consensus verification on the five transaction requests. During the consensus verification, because block chain nodes B and C both lack at least one of the five transaction requests, block chain nodes B and C may directly consider the pre-processing block including the five transaction requests as failed. In this example, more than half (in this case, two out of three) of the block chain nodes in the whole consensus network may consider the pre-processed block as failed during the consensus verification. As a result, the five transaction requests included in the pre-processed block will not be able to pass the consensus verification of the whole consensus network, and the five transaction requests will then not be recorded in block chains of the whole consensus network.

The other block chain nodes may consider the pre-processed block as failed in the consensus verification only because at least one of the transaction requests in the pre-processed block is not stored in the memories corresponding to the other block chain nodes. Failure can be determined in this case instead of a situation in which at least one of the transaction requests in the pre-processed block has been illegally tampered with. However, the transaction requests included in the pre-processed block may not actually have any problems. As a result, in conventional systems, a normal transaction request may be very likely to fail in the consensus verification of the block chain nodes, which can adversely affect transaction processing accuracy of the block chain system.

Techniques described in the present disclosure can be used to solve situations in which one or more of the transaction requests in the pre-processed block are missing. In some implementations, after a second block chain node receives a pre-processed block which is broadcast by a first block chain node and includes transaction requests, the second block chain node may determine that its memory does not include the full set of the transaction requests in the pre-processed block. The second block chain node may not directly consider the pre-processed block as failed in local consensus verification. Instead, the second block chain node can acquire the missing transaction requests from other block chain nodes in the whole consensus network. Once the missing transaction request are received, the second block chain node can carry out consensus verification by using the acquired transaction requests and the transaction requests already stored in its memory. In this way, adverse effects on consensus verification of transaction requests that may be caused by a network failure can be greatly reduced, which can improve the transaction processing accuracy of the block chain system.

In conventional systems, the process of carrying out transaction processing by a block chain node can include the following steps. After a terminal sends a transaction request to a block chain node, the block chain node may send the received transaction request to other block chain nodes by broadcasting. The other block chain nodes may store the received transaction request in their own memories. Further, the block chain node that sends the transaction request to the other block chain nodes may also store the transaction request in its own memory.

In a typical consensus network formed by block chain nodes, each block chain node may have the right to initiate a consensus request to other block chain nodes. The block chain node may arrange a set number of transaction requests stored in its own memory in a certain order. The order may be used to obtain, and generate a hash value for, a transaction request queue. The block chain node may then package the transaction request queue and the hash into a pre-processed block and send the pre-processed block to other block chain nodes by broadcasting, so as to perform consensus verification.

During the consensus verification, after receiving the pre-processed block, the other block chain nodes can verify the legality of asymmetric signatures of the transaction requests included in the pre-processed block. For example, each block chain node can parse the transaction requests included in the pre-processed block using a public key (for example, that is possessed locally) to verify whether the transaction requests are legal transaction requests. In some implementations, a private key can be used, depending on whether a private key or a public key is used when the transaction requests are encrypted.

Upon receiving a transaction request sent by a terminal, a given block chain node can broadcast the transaction request to the other block chain nodes in the whole consensus network. As a result, the memories corresponding to the block chain nodes can each typically store all of the transaction requests received within the whole consensus network. Upon receiving a pre-processed block from another block chain node, the other block chain nodes can each verify the hash integrity of the transaction requests in the pre-processed block. For example, each block chain node can search its own memory for the transaction requests included in the pre-processed block and arrange the found transaction requests according to an arrangement order of the transaction requests in the pre-processed block to obtain a transaction request queue. The block chain node can then generate a hash value for the transaction request queue and compare the obtained hash value with the hash value included in the pre-processed block. The comparison can be used to determine whether content of the transaction requests in the pre-processed block has been tampered with illegally.

In some implementations, by using asymmetric signature legality verification and the hash integrity verification carried out for the pre-processed block, each of the block chain nodes can obtain its own verification result regarding whether the pre-processed block as a whole is legal. The obtained verification result can then be broadcast to the other block chain nodes.

Using the verification results sent by the other block chain nodes for the pre-processed block and the verification result obtained locally, each of the block chain nodes can obtain an integrated verification result. The integrated verification result can indicate whether the pre-processed block passes the verifications of all of the block chain nodes in the whole consensus network. Each block chain node can further broadcast the obtained integrated verification result to the other block chain nodes.

After the integrated verification results have been broadcast among all of the block chain nodes, each block chain nodes can independently determine whether a majority of the integrated verification results obtained from the other block chain nodes indicate that the verification is successful. If so, then the transaction requests in the pre-processed block can be stored by the block chain node as blocks in its own block chain. Otherwise, the transaction requests in the pre-processed block can be refused by the block chain node.

After storing the transaction requests in the pre-processed block as blocks in its own block chain, each block chain node can release the transaction requests included in the pre-processed block from its own memory. This can make memory space available for storing additional transaction requests that are received.

In conventional systems, during a process of broadcasting transaction request, a network failure may prevent some transaction requests from being broadcast successfully. As a result, a number of transaction requests included in the pre-processed blocks that are broadcast by some block chain nodes can indicate that at least one transaction request is lacking. This can cause a failure of consensus verification that is subsequently performed, which can affect the transaction processing accuracy of the block chain system. Moreover, a failure of the consensus verification can cause the generation of a message that is sent to the user terminal (for example, serving as the block chain node) indicating that a processing failure of the transaction request has occurred, causing inconvenience to the user.

However, techniques described in the present disclosure can effectively solve the problem. For example, after a second block chain node receives a pre-processed block that is broadcast by a first block chain node, the second block chain node can determine at least one of the transaction requests is lacking from the pre-processed block. When that is the case, the second block chain node can acquire the missing transaction request(s) from other block chain nodes in the whole consensus network. The second block chain node can then carry out consensus verification on the transaction requests included in the pre-processed block by using the acquired transaction request(s) and transaction requests stored in its own memory. In this way, adverse effects on consensus verification of transaction requests caused by a network failure can be greatly reduced, and the transaction processing accuracy of the block chain system can be improved.

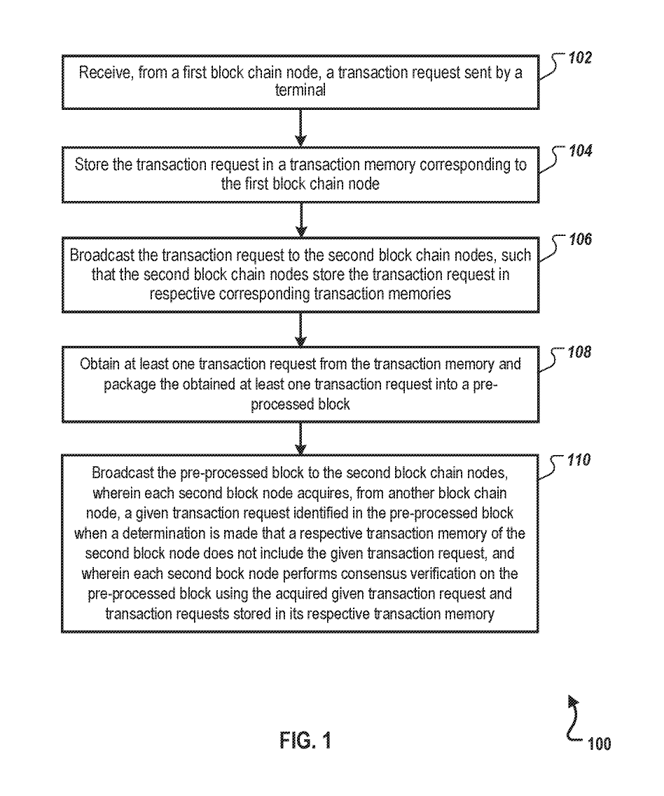

FIG. 1 is a schematic diagram of an example of a method 100 for completing consensus verification, according to an implementation of the present disclosure. For clarity of presentation, the description that follows generally describes method 100 in the context of the other figures in this description. However, it will be understood that method 100 can be performed, for example, by any system, environment, software, and hardware, or a combination of systems, environments, software, and hardware, as appropriate. In some implementations, various steps of method 100 can be run in parallel, in combination, in loops, or in any order.

At 102, a transaction request sent by a terminal is received by a first block chain node. For example, during transaction processing, a user can enter corresponding transaction processing content into a user terminal used by the user. The terminal can generate a corresponding transaction request according to the transaction processing content provided by the user and send the transaction request to a first block chain node in a whole consensus network. The terminal can be a computer device such as a computer or a smart phone. In some implementations, the user can also send the transaction request to the first block chain node by using a client terminal installed in the terminal. For example, the user can enter corresponding transaction processing content using a user interface presented on the client terminal. The client terminal can generate a corresponding transaction request according to the transaction processing content provided by the user, and the client terminal can send the transaction request to the first block chain node by using the terminal.

The consensus network can include multiple block chain nodes. The first block chain node can refer to a block chain node that receives the transaction request of the terminal. Block chain nodes other than the first block chain node can be referred to as second block chain nodes. As used in the present disclosure, the first block chain node and the second block chain node can be relative concepts. For example, the block chain node that receives the transaction request from the terminal can be referred to as the first block chain node, and the block chain node that receives the transaction request broadcast by the first block chain node can be referred to as the second block chain node. The block chain nodes in the consensus network can each receive the transaction request sent by the terminal. As a result, each of the block chain nodes can serve as the first block chain node or a second block chain node. Whether a block chain node is the first block chain node or the second block chain node depends on where the received transaction request originates or which node initiates the consensus verification. For example, a consensus verification initiator that broadcasts a pre-processed block including at least one transaction request to the whole consensus network can be determined to be the first block chain node. A block chain node that receives the pre-processed block can be referred to as the second block chain node. From 102, method 100 proceeds to 104.

At 104, the transaction request is stored in a memory corresponding to the first block chain node. For example, the transaction request that is generated based on the content provided by the user can be stored at the terminal, which serves as the first block chain node. From 104, method 100 proceeds to 106.

At 106, the transaction request is broadcast to second block chain nodes such that the second block chain nodes can store the transaction request in respective corresponding memories. As an example, the terminal can send the transaction request to the other block chain nodes in the whole consensus network. Each second block chain node can locally store the received transaction request. From 106, method 100 proceeds to 108.

At 108, at least one transaction request is obtained from the memory, and the obtained at least one transaction request is packaged into a pre-processed block. For example, the terminal can obtain one or more of the locally-stored transaction requests and package them into a pre-processed block. In some implementations, the selection of the transaction requests can be based, for example, on priority. For example, highest-priority transaction requests can be chosen for inclusion into the pre-processed block. From 108, method 100 proceeds to 110.

At 110, the pre-processed block is broadcast to the second block chain nodes. Each second block node acquires, from another block chain node, a given transaction request identified in the pre-processed block when a determination is made that a respective memory of the second block node does not include the given transaction request. Each second block node performs consensus verification on the pre-processed block using the acquired given transaction request and transaction requests stored in its respective memory, causing completion of the consensus verification by each of the second block chain nodes in the whole consensus network. After 110, method 100 stops.

In conventional systems, the first block chain node generally stores the received transaction request in a cache of its own. For example, the memory may be a cache of the block chain node and may have a limited storage space. Therefore, when the storage space of the cache is occupied completely, the first block chain node cannot continue to receive additional transaction requests sent by the terminal. Only after transaction requests in the cache are determined to pass the consensus verification can storage space be utilized to store the additional transaction request sent by the terminal. Therefore, in conventional systems, the storage space of the cache can greatly limit the transaction processing efficiency of the block chain system.

To solve such storage problems, implementations of the present disclosure can maintain a network of block chain nodes and their respective memories. Information, such as transaction requests, included in each memory can be stored in a database format and can be used, for example, to generate reports. Further, using a database to implement the memory can be more efficient that using a cache. The database can also allow the first block chain node to perform consensus verification while still continuing to receive transaction requests sent by the terminal. The use of the database can also meet the requirement of constantly growing transaction volume of the block chain system, and the transaction processing efficiency of the block chain system can be improved.

Another shortcoming of conventional systems that use a cache is that, when a block chain node is down or has other failures, the transaction requests stored in the cache can disappear. However, in implementations of the present disclosure, transaction requests that are stored in the database can be recovered even if a block chain node is down or has other failures, which can further assure the security of the transaction requests.

In some implementations, data transmission between the block chain nodes and the memories in the whole consensus network can be implemented by using preset distributed middleware. For example, after receiving the transaction request sent by the terminal, the first block chain node can send the transaction request to the distributed middleware. The distributed middleware can send, according to a node identifier of the first block chain node, the transaction request to the memory corresponding to the first block chain node for storage. Similarly, after receiving the transaction request broadcast by the first block chain node, the second block chain node can send the transaction request to the distributed middleware. The distributed middleware can also send, according to a node identifier of the second block chain node, the transaction request to the memory corresponding to the second block chain node for storage.

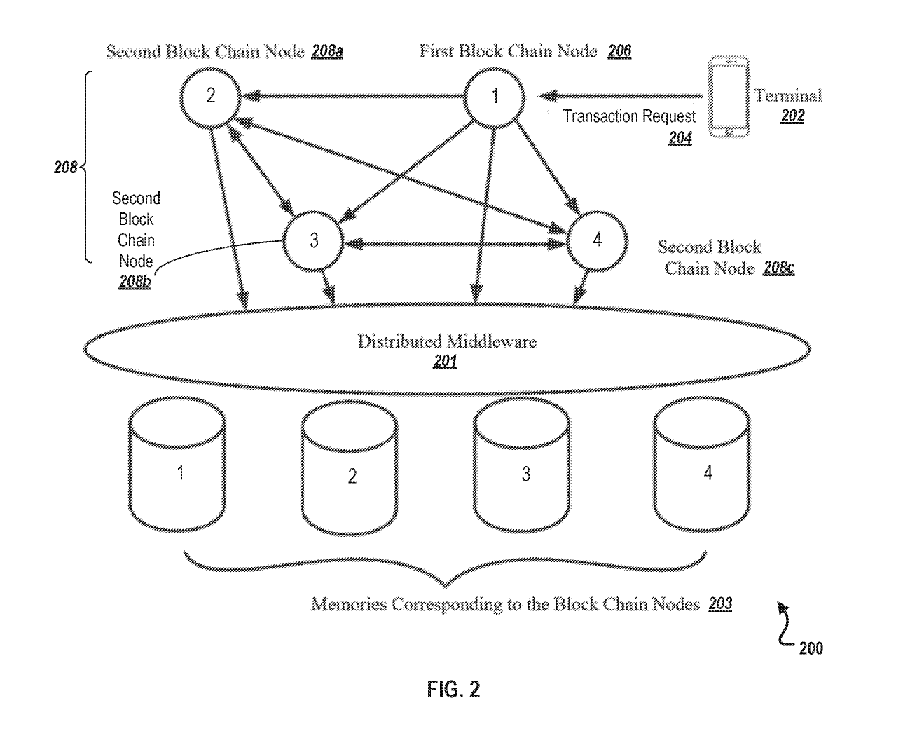

FIG. 2 is a block diagram of an example of a system 200 for storing, by block chain nodes, received transaction requests by using preset distributed middleware 201 according to an implementation of the present disclosure. For example, the preset distributed middleware can facilitate storage in the memories 203 corresponding to the respective block chain nodes.

As an example, when a user needs to carry out a transfer transaction, the user can select a transfer object in a terminal 202 held by the user, and enter a transfer amount. The terminal 202 can generate a corresponding transaction request 204 according to content entered by the user and send the transaction request 204 to a first block chain node 206.

After receiving the transaction request 204 sent by the terminal 202, the first block chain node 206 can send the transaction request 204 to preset distributed middleware 203. After that, the preset distributed middleware 201 can store, according to a node identifier of the first block chain node 206, the transaction request 204 in a memory corresponding to the first block chain node 206.

When receiving the transaction request 204, the first block chain node 206 can then broadcast the transaction request 204 to other block chain nodes, such as second block chain nodes 208. After receiving the transaction request 204, the second block chain nodes 208 can also send the transaction request 204 to the preset distributed middleware 201. After that, the preset distributed middleware 201 can store, according to respective node identifiers of the second block chain nodes 208, the transaction request 204 in respective memories 203 corresponding to the second block chain nodes 208.

In some implementations, when receiving the transaction request 204 sent by the first block chain node 206, the second block chain node 208 can also send the transaction request 204 to other block chain nodes. For a normal and legal transaction request 204, it can be expected that the transaction request 204 will pass consensus verification performed by the block chain nodes. Therefore, it can be expected that the transaction request 204 already exists in the memories 203 corresponding to the block chain nodes before the consensus verification is carried out.

However, network communications among the block chain nodes can experience failures such as network outages, network jitter, high network latency, and other issues. If the transaction request 204 is only broadcast by the first block chain node 206 while the second block chain nodes 208 fail to re-broadcast the transaction request 204 because of a network failure, this can adversely affect the consensus verification.

To prevent this situation, using techniques of the present disclosure, after receiving the transaction request 204 sent by the first block chain node 206, the second block chain node 208 can re-broadcast the transaction request 204 to other block chain nodes. When receiving the transaction request, the other block chain nodes can determine whether the transaction request 204 has been previously received. If so, then the other block chain nodes can ignore the transaction request 204. Otherwise, the other block chain nodes can store the transaction request in corresponding memories 203 using the preset distributed middleware 201.

In an example, when a failure occurs in network communication between the first block chain node 206 and a second block chain node 208b, the second block chain node 208b can still receive the transaction request 204 by way of a second block chain node 208a and a second block chain node 208c. Therefore, it can be assured that the transaction request 204 will be stored in the memories 203 of the block chain nodes in the whole consensus network to an extent possible when the transaction request 204 is a normal and legal transaction request 204.

In some implementations, in a process of storing the transaction request 204, the first block chain node 206 can first determine a transaction type corresponding to the transaction request 204. The first block chain node 206 transaction request 204 can sort the received transaction request 204 along with previously received transaction requests based on a preset priority sequence of transaction types.

In some implementations, different transactions can require different delays for transaction processing. For example, a for profit transaction can have a relatively strong requirement regarding a transaction processing delay. For example, it can be expected that the whole consensus network can finish processing the transaction quickly. A public benefit type transaction can have a less strong requirement regarding transaction processing delay. For example, the transaction will not be greatly affected even if the whole consensus network takes a longer time to process the transaction requests.

In some implementations, when storing the transaction request 204 in the memory corresponding to the first block chain node 206, the first block chain node 206 can rank the transaction request 204 in the memory according to a priority sequence of transactions, creating a ranked transaction queue including the transaction request 204. In the ranked transaction queue, transaction requests having stronger delay requirements can be assigned higher ranks, while transaction requests having weaker delay requirements can be assigned low ranks.

In some implementations, in addition to determining an arrangement sequence of transaction requests in a transaction queue according to the priority sequence of the transaction types, the first block chain node 206 can also comprehensively determine the arrangement sequence of the transaction requests in the memory according to storage time of the transaction requests in the memory. For example, when the storage time of a transaction request 204 in the memory is too long (for example, exceeds a threshold), the transaction request 204 can be lifted to the front of the whole transaction queue even if the transaction request 204 has a low requirement on delay.

When determining that the memory does not include one or more of the transaction requests 204 identified in the pre-processed block, each of the second block chain nodes 208 can acquire the identified transaction requests 204 from another block chain node. Then, each second block chain nodes 208 can perform consensus verification on the pre-processed block using the acquired transaction requests 204 and the transaction requests 204 stored in its memory.

In some implementations, the first block chain node 206 can establish a consensus for the transaction request 204 stored in its own memory by using the whole consensus network to finish processing the transaction request 204. For example, the first block chain node 206 can obtain at least one transaction request 204 from the memory. Then, the first block chain node 206 can establish a consensus for the at least one transaction request 204 by using the whole consensus network in a subsequent procedure.

In some implementations, the first block chain node 206 can obtain transaction requests with a transaction type higher than a set priority from the memory. For example, by using a transaction type as a constraint or a filter, the first block chain node 206 can obtain transaction requests of transaction types having priorities higher than the transaction type from the memory.

In some implementations, the first block chain node 206 can also obtain a set number of transaction requests from the memory. For example, when the transaction requests are stored in the memory in the form of a transaction queue, the first block chain node 206 can obtain a set number of transaction requests from the transaction queue. Further, the set number can represented by N, and the first block chain node 206 can obtain the first N (for example, N highest-ranked) transaction requests from the transaction queue.

In addition to obtaining the transaction requests according to the set number, the first block chain node 206 can also obtain the transaction requests according to another standard. For example, the first block chain node 206 can obtain transaction requests having storage time exceeding a preset time length in the memory. Alternatively, when establishing a consensus for the transaction requests by using the whole consensus network, the first block chain node 206 can select a transaction and obtain transaction requests corresponding to the transaction from the memory. The first block chain node 206 can select the transaction randomly or select the transaction according to a certain sequence. In another example, the first block chain node 206 can further obtain transaction requests according to other standards.

After the first block chain node 206 obtains the set number of transaction requests, sub-characteristic values corresponding to the transaction requests can be determined respectively according to a preset characteristic value determination rule. For example, when the preset characteristic value determination rule is a hash algorithm, the first block chain node 206 can determine sub-hash values corresponding to the transaction requests respectively. When the preset characteristic value determination rule is a message digest algorithm (for example, MD5), the first block chain node 206 can determine sub-MD5 values corresponding to the transaction requests respectively.

After the first block chain node 206 determines the sub-characteristic values corresponding to the transaction requests, to-be-verified characteristic values that uniquely corresponds to the transaction requests can be determined according to the determined characteristic values and the arrangement sequence of the transaction requests in the memory. Each to-be-verified characteristic value can uniquely correspond to the transaction requests as a whole. For example, when content of a transaction request 204 among the transaction requests is changed, the to-be-verified characteristic value can be changed.

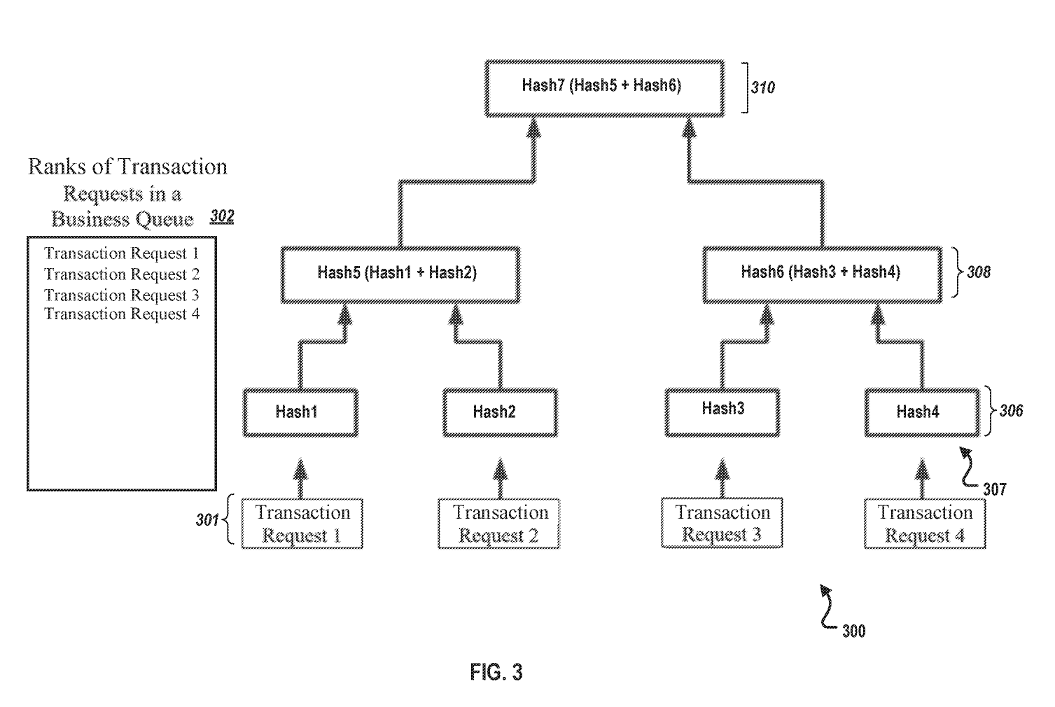

FIG. 3 is a block diagram of an example of a system 300 for determining a to-be-verified characteristic value, according to an implementation of the present disclosure. For example, a characteristic value determination rule used by the first block chain node 206 can be a hash algorithm. Assume that the first block chain node 206 obtains a set number of (for example, four) transaction requests 301 from the memory. Arrangement of the four transaction requests 301 in a transaction queue 302 can be made as shown in FIG. 3. After determining four hash values corresponding to the four transaction requests 301 respectively, the first block chain node 206 can place the four hash values on four leaf nodes 306 of a Merkle tree 307. For example, the placement can be from left to right according to ranks of the four transaction requests 301 in the transaction queue 302. The first block chain node 206 can then determine non-leaf nodes 308 and a root node 310 of the Merkle tree 307 accordingly. The first block chain node 206 can then determine the root node 310 (for example, Hash7) of the Merkle tree 307 as a to-be-verified characteristic value uniquely corresponding to the four transaction requests 301.

Other methods for determining the to-be-verified characteristic value can also be used. For example, the first block chain node 206 can also make the determination in other manners, as long as it can be assured that the to-be-verified characteristic values uniquely correspond to the transaction requests 301 in a certain sequence.

After determining the to-be-verified characteristic value uniquely corresponding to the transaction requests 301 (for example, the at least one transaction request 204 obtained from the memory), the first block chain node 206 can package the to-be-verified characteristic value and the transaction requests 301 into a pre-processed block. The pre-processed block can include the transaction requests 301 and the to-be-verified characteristic value. The transaction requests 301 in the pre-processed block can be arranged according to the arrangement sequence of the transaction requests 301 in the memory.

The first block chain node 206 can broadcast the determined pre-processed block to other block chain nodes (for example, the second block chain nodes 208) in the whole consensus network, and then the whole consensus network can establish a consensus on the transaction requests 301 included in the pre-processed block.

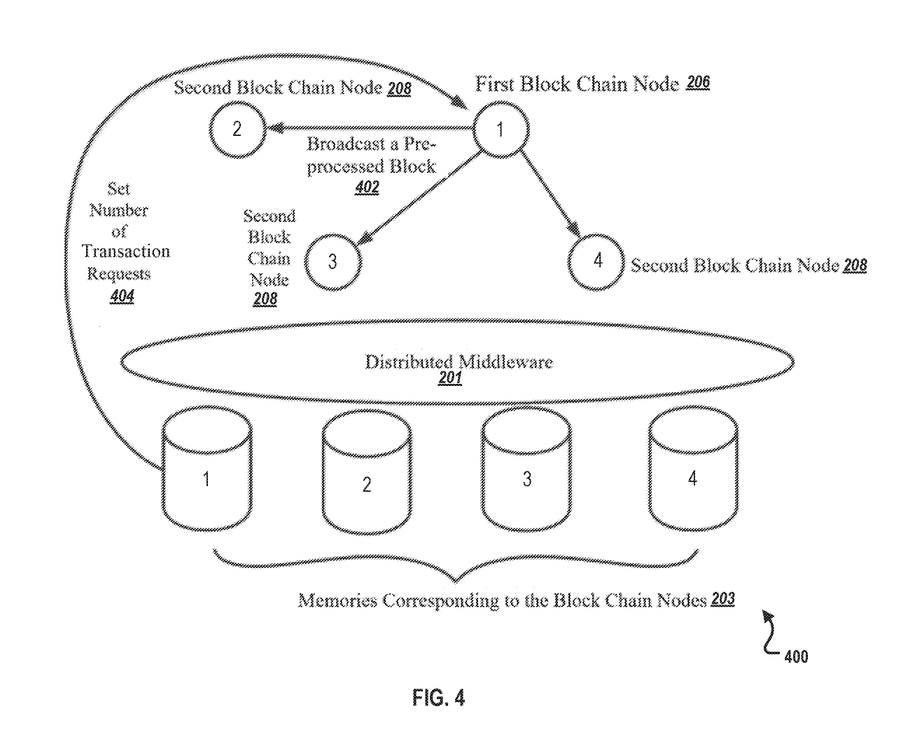

FIG. 4 is a block diagram of an example of a system 400 for establishing a consensus by a consensus network, according to an implementation of the present disclosure. For example, the consensus can apply to a pre-processed block sent by a first block chain node 206.

The first block chain node 206 can broadcast the pre-processed block 402 to the second block chain nodes 208 in the whole consensus network. For each of the second block chain nodes 208, when receiving the pre-processed block 402 sent by the first block chain node 206, the second block chain node 208 can parse the pre-processed block 402 to determine the transaction requests and the to-be-verified characteristic value that are included in the pre-processed block 402. For each of the second block chain nodes 208, after obtaining (for example, by parsing) a set number of transaction requests 404 from the pre-processed block 402, the second block chain node 208 can then carry out asymmetric signature legality verification on the transaction requests, for example, to verify whether the transaction requests are all legal transaction requests.

In some implementations, when sending a transaction request 204 to a block chain node, the terminal 202 can encrypt (for example, sign) the transaction request 204 by using a possessed private key (or a public key). Then, when carrying out the asymmetric signature legality verification on the transaction requests included in the pre-processed block, the second block chain node can parse the transaction requests by using a public key to verify content obtained through parsing. In some implementations, when the terminal 202 carries out encryption by using the public key, the second block chain node 208 can parse the transaction requests by using a private key.

In another example, when carrying out the asymmetric signature legality verification on a transaction request (for example, the transaction request 204) in the pre-processed block, the second block chain node 208 can decrypt the transaction request 204 by using a locally available public key. The second block chain node 208 can obtain account addresses of both transaction parties involved in the transaction request 204, for example, to verify whether the account addresses of the both transaction parties are legal. When it is determined that the account addresses of the both transaction parties involved in the transaction request 204 are legal accounts (and the amount of money stored in an account of a transaction initiator is greater than or equal to a transfer amount involved in the transaction request 204), it can be determined that the transaction request 204 passes the asymmetric signature legality verification. Otherwise, it can be determined that the transaction request 204 has failed in the asymmetric signature legality verification.

After determining that the transaction requests included in the pre-processed block all pass the asymmetric signature legality verification, the second block chain node 208 can further determine sub-characteristic values corresponding to the transaction requests by using a preset characteristic value determination rule. The characteristic value determination rule used by the second block chain node 208 can be the same as that used by the first block chain node 206.

After determining the sub-characteristic values corresponding to the transaction requests, the second block chain node 208 can determine a characteristic value uniquely corresponding to the transaction requests as a whole according to an arrangement sequence of the transaction requests in the pre-processed block and the sub-characteristic values. The second block chain node 208 can then compare the characteristic value with the to-be-verified characteristic value in the pre-processed block. When the two characteristic values are the same, it can be determined that content of the transaction requests on which a consensus needs to be established by the first block chain node 206 has not changed. For example, it can be determined that the transaction requests pass the hash integrity verification.

After the second block chain nodes 208 carry out the asymmetric signature legality verification and the hash integrity verification on the pre-processed block, local verification results for the pre-processed block can be obtained respectively. This can occur when the transaction requests in the pre-processed block all pass the asymmetric signature legality verification and the hash integrity verification, at which time the local verification result of the pre-processed block can indicate a success. The local verification result of the pre-processed block can indicate a failure once it is determined that either of the verifications is unsuccessful. Each of the second block chain nodes 208 can then broadcast the respective obtained verification result to other block chain nodes in the whole consensus network so as to initiate consensus verification. After receiving the verification results that are broadcast among the block chain nodes, each of the block chain nodes in the whole consensus network can obtain an integrated verification result. The integrated verification result can indicate whether the transaction requests included in the pre-processed block passes the verifications of the block chain nodes in the whole consensus network. The obtained integrated verification result can then be further broadcast to the other block chain nodes in the whole consensus network.

After receiving the integrated verification results broadcast among the block chain nodes, each of the block chain nodes in the consensus network can further determine whether a majority of the integrated verification results obtained by the block chain nodes in the consensus network indicate that the verification is successful. If a success majority is indicated, then the transaction requests included in the pre-processed block can be written into a block for storage. Also, the block can be further written into a block chain in which the block is stored, according to a time sequence. If success majority is not indicated, then the transaction requests can be refused. In some implementations, consensus verification procedure can use one or more consensus algorithms, for example, a Practical Byzantine Fault Tolerance (PBFT) algorithm, a consistency algorithm (for example, Raft), or a Paxos algorithm.

In some implementations, after a block chain node (such as the first block chain node 206 or the second block chain node 208) stores the transaction requests in the block chain as blocks, storage space occupied by the transaction requests in respective memories 203 can be released. Then, the transaction requests can be transferred, for example, archived, to a database used for storing historical transaction requests.

In some implementations, the second block chain nodes 208 can further broadcast the transaction request 204 of the first block chain node 206. However, some block chain nodes in the whole consensus network may still be unable to receive the transaction request 204 effectively due to existing network problems. Therefore, during the consensus stage, when a second block chain node does not find, within its memory, at least one of the transaction request 204 expected in the pre-processed block, the second block chain node can send a query message for acquiring a missing transaction request 204. The request can be sent to another block chain node by using a preset distributed middleware 201. After receiving the query message, the other block chain node can determine whether its memory includes the missing transaction request 204. If so, then the other block chain node can return a reply message to the second block chain node. Otherwise, the other block chain node can decide not to return the reply message to the second block chain node.

After receiving the reply message, the second block chain node can acquire, by using the preset distributed middleware 201, the missing transaction request 204 from the memory corresponding to the block chain node sending the reply message. The second block chain node can then carry out the asymmetric signature legality verification on the transaction request 204. When determining that the transaction request 204 passes the asymmetric signature legality verification, the second block chain node 208 can store the transaction request 204 in its memory. The second block chain node 208 can store the transaction request 204 in its memory according to an arrangement sequence of the transaction requests in the pre-processed block. When determining that the transaction request 204 does not pass the asymmetric signature legality verification, the second block chain node 208 can decide not to store the transaction request 204. The second block chain node 208 can determine that the pre-processed block sent by the first block chain node 206 fails the local consensus verification.

After receiving the transaction request 204 from the other block chain node, if the second block chain node 208 still receives the same transaction request 204 from other block chain nodes, the second block chain node 208 can ignore the transaction request 204. Further, it is unnecessary to repeat carrying out the asymmetric signature legality verification and storage of the transaction request 204.

In some implementations, the whole consensus network can be a consensus network of a consortium chain. For example, the block chain nodes can be block chain nodes in the consortium chain. The first block chain node 206 can be a leader node in a consortium chain consensus algorithm, and the second block chain node can be a non-leader node in the consortium chain consensus algorithm.

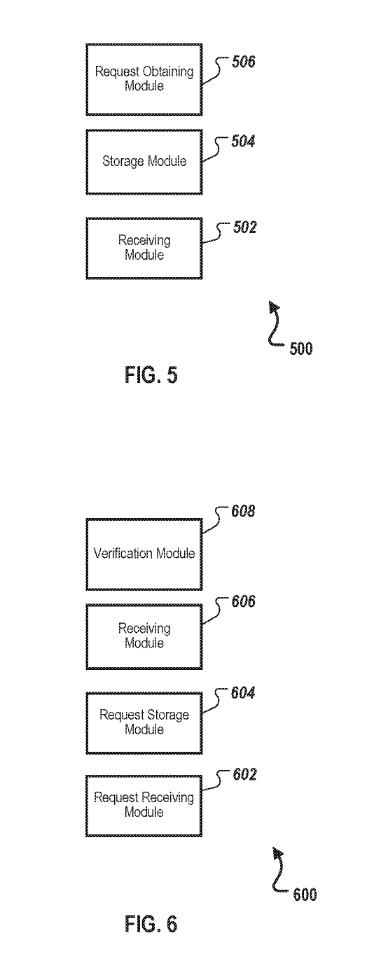

FIG. 5 is a block diagram of an example of a transaction verification system 500, according to an implementation of the present disclosure. A receiving module 501 can be configured to receive a transaction request 204 sent by a terminal. A storage module 502 can be configured to store the transaction request 204 in a memory corresponding to the system and broadcast the transaction request 204 to second block chain nodes 208. As a result, that the second block chain nodes 208 can store the transaction request 204 in respective corresponding memories 203. A request obtaining module 503 can be configured to obtain at least one transaction request 204 from the memory, package the obtained at least one transaction request 204 into a pre-processed block, and broadcast the pre-processed block to the second block chain nodes 208. As a result, when a given one of the second block chain nodes 208 determines that its memory does not include at least one of the transaction requests 204 identified in the pre-processed block, the second block chain node 208 can acquire the identified transaction requests 204 from another block chain node. The second block chain nodes 208 can then carry out consensus verification on the pre-processed block by using the obtained transaction request 204 and the transaction requests 204 already stored in its memory. In some implementations, the memory can be a database that can store transaction requests.

In some implementations, the storage module 502 can also be can be configured to store the transaction request 204 in the memory by using the preset distributed middleware 201. The request obtaining module 503 can also be can be configured to obtain, from the memory, a set number of transaction requests with a transaction type higher than a set priority. The storage module 502 can also be configured to store the transaction request 204 in the memory according to the transaction type of the transaction request 204 and a preset priority sequence of transaction types. The system 500 can be a leader node in a consortium chain consensus algorithm, and the second block chain node 208 can be a non-leader node in the consortium chain consensus algorithm.

FIG. 6 is a schematic diagram of another transaction verification system 600, according to an implementation of the present disclosure. A request receiving module 601 can be configured to receive a transaction request 204 broadcast by a first block chain node 206. A request storage module 602 can be configured to store the transaction request 204 in a memory corresponding to the system. A receiving module 603 can be configured to receive a pre-processed block that is broadcast by the first block chain node 206 and includes at least one transaction request 204. The receiving module 603 can also acquire transaction requests 204 from another block chain node when it is determined that a local memory does not include at least one of the transaction requests 204 identified in the pre-processed block. A verification module 604 can be configured to carry out consensus verification on the pre-processed block by using at least one received transaction request 204 and a transaction request 204 stored in its memory.

In some implementations, the receiving module 603 can also be configured to send a query message for acquiring the transaction request 204, the query message being sent to another second block chain node or to the first block chain node 206. For example, the query message can be sent when it is determined that the memory does not include at least one of the transaction requests 204 identified in the pre-processed block. The receiving module 603 can also receive a reply message returned by the other second block chain node 208 or the first block chain node 206. The reply message can indicate that a memory corresponding to the other second block chain node 208 or the first block chain node 206 sending the reply message stores the at least one transaction request 204. The receiving module 603 can also acquire the at least one transaction request 204 from the memory corresponding to the second block chain node 208 or the first block chain node 206 that sent the reply message.

In some implementations, a first block chain node 206 can package at least one transaction request 204 obtained from a memory of the first block chain node 206 into a pre-processed block. The first block chain node 206 can broadcast the pre-processed block to second block chain nodes 208. If the second block chain node 208 determines that its memory does not include at least one of the transaction requests 204 identified in the pre-processed block, the second block chain node 208 can acquire the at least one transaction request 204 from another block chain node. The first block chain node 206 can then carry out consensus verification on the transaction request 204 included the pre-processed block by using the at least one transaction request 204 and a transaction request 204 already stored in its memory. When a second block chain node 208 determines, after receiving a pre-processed block broadcast by a first block chain node 206, that its memory does not include at least one of the transaction requests 204 in the pre-processed block, the second block chain node 208 can decide not to consider the pre-processed block as failed in local consensus verification. Instead, the second block chain node 208 can acquire the missing transaction requests 204 from other block chain nodes in the whole consensus network. Then, the second block chain node 208 can carry out consensus verification on the pre-processed block by using the acquired transaction requests and transaction requests stored in its memory. In this way, adverse effects on consensus verification of transaction requests caused by a network failure can be reduced, which can improve the transaction processing accuracy of the block chain system.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, that is, one or more modules of computer program instructions, encoded on non-transitory computer storage media for execution by, or to control the operation of, data processing apparatus. Alternatively or in addition, the program instructions can be encoded on an artificially generated propagated signal, for example, a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (for example, multiple Compact Discs (CDs), Digital Video Discs (DVDs), magnetic disks, or other storage devices).

The operations described in this specification can be implemented as operations performed by a data processing apparatus on data stored on one or more computer-readable storage devices or received from other sources.

The terms “data processing apparatus,” “computer,” or “computing device” encompass all kinds of apparatus, devices, and machines for processing data, including by way of example a programmable processor, a computer, a system on a chip, or multiple ones, or combinations, of the foregoing. The apparatus can include special purpose logic circuitry, for example, a central processing unit (CPU), a field programmable gate array (FPGA) or an application specific integrated circuit (ASIC). The apparatus can also include, in addition to hardware, code that creates an execution environment for the computer program in question, for example, code that constitutes processor firmware, a protocol stack, a database management system, an operating system (for example, LINUX, UNIX, WINDOWS, MAC OS, ANDROID, IOS, another operating system, or a combination of operating systems), a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, software module, software unit, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (for example, one or more scripts stored in a markup language document), in a single file dedicated to the program in question, or in multiple coordinated files (for example, files that store one or more modules, sub programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, for example, magnetic, magneto optical disks, or optical disks. However, a computer need not have such devices. Moreover, a computer can be embedded in another device, for example, a mobile device, a personal digital assistant (PDA), a game console, a Global Positioning System (GPS) receiver, or a portable storage device (for example, a universal serial bus (USB) flash drive), to name just a few. Devices suitable for storing computer program instructions and data include all forms of non-volatile memory, media and memory devices, including, by way of example, semiconductor memory devices, for example, erasable programmable read-only memory (EPROM), electrically erasable programmable read-only memory (EEPROM), and flash memory devices; magnetic disks, for example, internal hard disks or removable disks; magneto optical disks; and CD ROM and DVD-ROM disks. The processor and the memory can be supplemented by, or incorporated in, special purpose logic circuitry.

Mobile devices can include mobile telephones (for example, smartphones), tablets, wearable devices (for example, smart watches, smart eyeglasses, smart fabric, smart jewelry), implanted devices within the human body (for example, biosensors, smart pacemakers, cochlear implants), or other types of mobile devices. The mobile devices can communicate wirelessly (for example, using radio frequency (RF) signals) to various communication networks (described below). The mobile devices can include sensors for determining characteristics of the mobile device's current environment. The sensors can include cameras, microphones, proximity sensors, motion sensors, accelerometers, ambient light sensors, moisture sensors, gyroscopes, compasses, barometers, fingerprint sensors, facial recognition systems, RF sensors (for example, Wi-Fi and cellular radios), thermal sensors, or other types of sensors.

To provide for interaction with a user, embodiments of the subject matter described in this specification can be implemented on a computer having a display device, for example, a cathode ray tube (CRT) or liquid crystal display (LCD) monitor, for displaying information to the user and a keyboard and a pointing device, for example, a mouse or a trackball, by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented using computing devices interconnected by any form or medium of wireline or wireless digital data communication (or combination thereof), for example, a communication network. Examples of communication networks include a local area network (LAN), a radio access network (RAN), a metropolitan area network (MAN), and a wide area network (WAN). The communication network can include all or a portion of the Internet, another communication network, or a combination of communication networks. Information can be transmitted on the communication network according to various protocols and standards, including Worldwide Interoperability for Microwave Access (WIMAX), Long Term Evolution (LTE), Code Division Multiple Access (CDMA), 5G protocols, IEEE 802.11 a/b/g/n or 802.20 protocols (or a combination of 802.11x and 802.20 or other protocols consistent with the present disclosure), Internet Protocol (IP), Frame Relay, Asynchronous Transfer Mode (ATM), ETHERNET, or other protocols or combinations of protocols. The communication network can transmit voice, video, data, or other information between the connected computing devices.

Embodiments of the subject matter described in this specification can be implemented using clients and servers interconnected by a communication network. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method comprising:
receiving, by a first block chain node, a transaction request sent by a terminal;
storing the transaction request in a memory corresponding to the first block chain node;
broadcasting the transaction request to second block chain nodes, such that the second block chain nodes store the transaction request in respective memories;
obtaining at least one transaction request from the memory and packaging the obtained at least one transaction request into a pre-processed block; and
broadcasting the pre-processed block to the second block chain nodes, wherein each second block node acquires, from another block chain node, a given transaction request identified in the pre-processed block when a determination is made that a respective memory of the second block node does not include the given transaction request, and wherein each second block node performs consensus verification on the pre-processed block using the acquired given transaction request and transaction requests stored in its respective memory.

2. The computer-implemented method of claim 1, wherein the memory is a database that stores transaction requests.

3. The computer-implemented method of claim 2, wherein storing the transaction request in the memory corresponding to the first block chain node comprises storing the transaction request in the memory by using preset distributed middleware.

4. The computer-implemented method of any of claim 1, wherein obtaining at least one transaction request from the memory comprises obtaining, from the memory, a set number of transaction requests with a transaction type higher than a set priority.

5. The computer-implemented method of claim 4, wherein storing the transaction request in a memory corresponding to the first block chain node comprises storing the transaction request in the memory according to the transaction type of the transaction request and a preset priority sequence of transaction types.

6. The computer-implemented method of claim 1, wherein the first block chain node is a leader node in a consortium chain consensus algorithm, and wherein the second block chain node is a non-leader node in the consortium chain consensus algorithm.

7. The computer-implemented method of claim 1, wherein acquiring the given transaction request from another block chain node comprises:
sending a query message for acquiring the given transaction request to another second block chain node or the first block chain node;
receiving a reply message returned by the other second block chain node or the first block chain node, the reply message indicating that the given transaction request is available in the memory of the other second block chain node or the first block chain node; and
acquiring the given transaction request from the other second block chain node or the first block chain node.

8. A non-transitory, computer-readable medium storing one or more instructions executable by a computer system to perform operations comprising:
receiving, by a first block chain node, a transaction request sent by a terminal;
storing the transaction request in a memory corresponding to the first block chain node;
broadcasting the transaction request to second block chain nodes, such that the second block chain nodes store the transaction request in respective memories;
obtaining at least one transaction request from the memory and packaging the obtained at least one transaction request into a pre-processed block; and
broadcasting the pre-processed block to the second block chain nodes, wherein each second block node acquires, from another block chain node, a given transaction request identified in the pre-processed block when a determination is made that a respective memory of the second block node does not include the given transaction request, and wherein each second block node performs consensus verification on the pre-processed block using the acquired given transaction request and transaction requests stored in its respective memory.

9. The non-transitory, computer-readable medium of claim 8, wherein the memory is a database that stores transaction requests.

10. The non-transitory, computer-readable medium of claim 9, wherein storing the transaction request in the memory corresponding to the first block chain node comprises storing the transaction request in the memory by using preset distributed middleware.

11. The non-transitory, computer-readable medium of claim 8, wherein obtaining at least one transaction request from the memory comprises obtaining, from the memory, a set number of transaction requests with a transaction type higher than a set priority.

12. The non-transitory, computer-readable medium of claim 11, wherein storing the transaction request in a memory corresponding to the first block chain node comprises storing the transaction request in the memory according to the transaction type of the transaction request and a preset priority sequence of transaction types.

13. The non-transitory, computer-readable medium of claim 8, wherein the first block chain node is a leader node in a consortium chain consensus algorithm, and wherein the second block chain node is a non-leader node in the consortium chain consensus algorithm.

14. The non-transitory, computer-readable medium of claim 8, wherein acquiring the given transaction request from another block chain node comprises:
sending a query message for acquiring the given transaction request to another second block chain node or the first block chain node;
receiving a reply message returned by the other second block chain node or the first block chain node, the reply message indicating that the given transaction request is available in the memory of the other second block chain node or the first block chain node; and
acquiring the given transaction request from the other second block chain node or the first block chain node.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving, by a first block chain node, a transaction request sent by a terminal;
storing the transaction request in a memory corresponding to the first block chain node;
broadcasting the transaction request to second block chain nodes, such that the second block chain nodes store the transaction request in respective memories;
obtaining at least one transaction request from the memory and packaging the obtained at least one transaction request into a pre-processed block; and
broadcasting the pre-processed block to the second block chain nodes, wherein each second block node acquires, from another block chain node, a given transaction request identified in the pre-processed block when a determination is made that a respective memory of the second block node does not include the given transaction request, and wherein each second block node performs consensus verification on the pre-processed block using the acquired given transaction request and transaction requests stored in its respective memory.

16. The computer-implemented system of claim 15, wherein the memory is a database that stores transaction requests.

17. The computer-implemented system of claim 16, wherein storing the transaction request in the memory corresponding to the first block chain node comprises storing the transaction request in the memory by using preset distributed middleware.

18. The computer-implemented system of claim 15, wherein obtaining at least one transaction request from the memory comprises obtaining, from the memory, a set number of transaction requests with a transaction type higher than a set priority.

19. The computer-implemented system of claim 18, wherein storing the transaction request in a memory corresponding to the first block chain node comprises storing the transaction request in the memory according to the transaction type of the transaction request and a preset priority sequence of transaction types.

20. The computer-implemented system of claim 15, wherein the first block chain node is a leader node in a consortium chain consensus algorithm, and wherein the second block chain node is a non-leader node in the consortium chain consensus algorithm.
